(19) United States
(12) Patent Application Publication
(10) Pub. No.: US 2008/0267360 A1
(43) Pub. Date: Oct. 30, 2008

(54) Emergency Situation and Information Communication Systems

(76) Inventor: Donald Spector, New York, NY (US)

Correspondence Address: DIEHL SERVILLA LLC, 77 BRANT AVE, SUITE 210, CLARK, NJ, 07066, US

(21) Appl. No.: 12/110,853

(22) Filed: Apr. 28, 2008

Related U.S. Application Data
(60) Provisional application No. 60/914,740, filed on Apr. 28, 2007.
(60) Provisional application No. 60/940,102, filed on May 25, 2007.
(60) Provisional application No. 60/968,027, filed on Aug. 24, 2007.

(51) Int. Cl. H04M 11/04

(52) U.S. Cl. 379/45

(57) ABSTRACT

Systems and methods for locating first responders for an emergency situation is disclosed. A Global Positioning System for determining a geographical location of a responder connected to a personal computing device is also disclosed. Identity of a responder, availability of a responder, skills and training of a responder and location of a responder are stored in a databank. A system can select an appropriate responder and call a responder to duty when an emergency occurs. Systems and methods for alerting the public to an emergency situation are also disclosed.

### CROSS-REFERENCE TO RELATED APPLICATIONS

This application claims the benefit under 35 U.S.C. 119(e) of U.S. Provisional Application No. 60/914,740, filed Apr. 28, 2007, U.S. Provisional Application No. 60/940,102, filed May 25, 2007, and U.S. Provisional Application No. 60/968,027, filed Aug. 24, 2007. Each of the patent applications identified in this paragraph are incorporated herein by reference in their entirety as if fully set forth herein.

### BACKGROUND OF THE INVENTION

The present invention relates to systems and methods for communicating information regarding emergency situations that can include alerting on-call auxiliary personnel that corporations or governments need in emergency situations. More specifically it relates to systems and methods that alert available personnel with adequate training to address specific situations.

Present systems for calling people require agencies or authorities to call their reserve people or first responders, for instance on their home phone, cell phone, contact by email. Through an automatically generated mechanism, or a prompt, one can “find out” who is calling back or who was reached. An agency then presumably can access the degree of training of a respondent from for instance a database. Especially if a response is received from, for instance a mobile phone, it is difficult to determine where the respondent physically is located without first talking with the person. Obviously, during emergency situations this type of system to alert and engage first responders takes an excessive amount of time, in situations where time is of the essence.

In recent years, the use of Medi-Alert and other home features that allow the elderly or infirm to communicate directly and rapidly with emergency help have been a growing and important part of a medical lifeline. These versions often have a box, in the person's home that allows the person to call for help and speak to a person in the event of an emergency. The box, coupled with the user profile information and the two-way communication can dispatch help much more quickly than traditional emergency responders. Systems such as OnStar®, which allow a person to select various services within a geopositioning area or can dispatch help are also well known.

Accordingly new and improved systems and methods for alerting and engaging with appropriate first responders are required.

### SUMMARY OF THE INVENTION

One or more aspects of the present invention present novel methods and systems that will provide a more efficient way to alert first responders and the public in case of an emergency.

In accordance with another aspect of the present invention a system is provided for alerting a first responder to report for duty in case of an emergency event, comprising an emergency control center, including a databank comprising information on the first responder, the information including information about a skill of the first responder; a network; a personal computing device enabled to communicate with the emergency control center; a positioning unit, connected with the personal computing device, enabled to provide geographical location information to the personal computing device, the personal computing device enabled to provide the location information to the emergency control center; and software enabling the emergency control center to select from the databank the first responder for duty based on the skill of the first responder, an availability of the first responder and a geographical location of the first responder.

In accordance with a further aspect of the present invention a system is provided wherein the personal computing device is a cell phone.

In accordance with another aspect of the present invention a system is provided wherein the positioning unit is a Global Positioning System (GPS) receiver or other location based system of determining where the responder is.

In accordance with a further aspect of the present invention a system is provided wherein the network comprises a wireless network.

In accordance with another aspect of the present invention a method for alerting a first responder to report for duty in case of an emergency event is provided, comprising the steps of determining a skill of the first responder and registering the skill in a databank; tracking a geographical location of the first responder through a network; determining an availability of the first responder; selecting the first responder based on the geographical location, the availability and the skill; and alerting the first responder to report for duty.

In accordance with a further aspect of the present invention a method for alerting a first responder to report for duty is provided wherein the first responder has opted-in for the tracking of the geographical location.

In accordance with another aspect of the present invention a method for alerting a first responder to report for duty in case of an emergency event is provided wherein the network comprises a wireless network.

In accordance with another aspect of the present invention a method for alerting a first responder to report for duty in case of an emergency event is provided wherein the geographical location is determined by a global positioning system (GPS) receiver.

In accordance with a further aspect of the present invention a personal computing device for alerting a first responder for duty in case of an emergency event is provided, comprising: a transceiver to communicate with an emergency control center, the transceiver being connected to a network, the network enabled to connect to an emergency control center having a databank; a means for determining a geographical location of the personal computing device; a facility to opt-in for tracking of the geographical location; and the databank enabled to select the first responder using an availability of the first responder, a skill and the geographical location of the first responder.

In accordance with another aspect of the present invention a personal computing device for alerting a first responder for duty is provided, further comprising a message to alert the first responder to report for duty.

In accordance with a further aspect of the present invention a personal computing device for alerting a first responder for duty is provided, wherein the network includes a wireless network.

In accordance with another aspect of the present invention a personal computing device for alerting a first responder for duty is provided, wherein the personal computing device is a cell phone.

In accordance with a further aspect of the present invention a personal computing device for alerting a first responder for duty is provided, wherein the personal computing device is a personal digital assistant (PDA).

In accordance with another aspect of the present invention a personal computing device for alerting a first responder for duty is provided, wherein the network includes an Internet.

In accordance with a further aspect of the present invention a personal computing device for alerting a first responder for duty is provided, wherein the means for determining a geographical location is a global positioning system (GPS) receiver.

Further aspects of the invention are directed to emergency alert systems. A control center may be used to control messages flowing to a plurality of displays. The displays and the control center share a network, which can be wireless, wired, satellite, or any other suitable network. The displays are mainly located outside of the control center, with some being in the control center, as needed. The global position of each of the displays is known to the control center software. The global position can be hard-wired into the display, programmed into the software, transmitted dynamically by use of a GPS system, or by any other suitable locating means. Software run from the control center controls the messages that appear on the displays.

The message shown on the display can be interrupted or changed by a local, state, federal government or government agency as needed. This governmental change can be accomplished by either control from outside of the control center or by communication with the control center.

The displays of some aspects of the invention display a message based on the global position of the display. For example, displays within a disaster area may provide instructions to the people or emergency crews within the area. Whereas, the displays outside of the disaster area may direct people away from the scene.

Other embodiments of the system include a standard telephone. This telephone may be a pay phone or free for anyone's use. The displays of these and other embodiments may include an advertisement or series of advertisements which the telephone user is presented with during their phone call. If an emergency message is used, the advertisement will be interrupted for the message.

### BRIEF DESCRIPTION OF THE DRAWINGS

FIG. 1 illustrates a system in accordance with one aspect of the present invention.

FIG. 2 illustrates a databank in accordance with one aspect of the present invention.

FIG. 3 illustrates a series of steps performed by an emergency control center in accordance with one aspect of the present invention.

### DETAILED DESCRIPTION

Current systems and methods for alerting first responders to respond to an emergency and getting first responders to designated locations have serious draw backs. A first problem is that people have to be reached on home phones, mobile phones or via emails by an agency or an emergency authority from which a first responder can then provide a response. From a response an authority can find out who responded, and potentially in a database one can find out what skills or training the person possesses. One also needs to know if the person is close to the area of the emergency. Clearly rapidly finding first responders with adequate training and skills, with availability and a presence close enough to the area of the emergency can be a challenge and may require too much time in situations where time is of the essence.

Additionally, one would want first responders on the scene of an emergency who are adequately trained. For many situations it is not practical or useful to have people on an emergency scene who have not received a specific training. For instance, the Homeland Security department would not want to call up people for a dirty bomb emergency that had not had the course associated with such a response. Those responders would actually be in the way.

Furthermore it would not be practical to depend on first responders having to travel for instance four hours to an emergency scene when trained responders are available within one hour of travel.

In accordance with an aspect of the present invention a Global Positioning System (GPS) is used for identifying and alerting first responders to an emergency. Potential first responders will have a personal computing device, which may for instance be a mobile phone, a personal digital assistant (PDA) such as a Blackberry, a computer or a car based system such as OnStar which is connected to a geographical positioning system that is able to provide the physical location of the personal computing device through a communication link with an appropriate accuracy to a central system.

Some embodiments of the invention include systems that are connected to a GPS system, which volunteers can opt-in or out from. Included are processes in which dedicated people are assigned specific hours of availability. The times might be predetermined or they might be a physical button during with GPS positioning is an optional feature. Otherwise the GPS tracking might be thought of as an invasion of privacy and reduce the number of people who would be available.

With the advent of more sophisticated communications, better geopositioning data and the use of opt-in, along with special private responders, that can e linked to include multiple areas, it is believed that such systems can be linked through programs that can be applied to a cellular phone service, such as Reward Phone to create an extra feature.

The use of cell phones, while presently limited to combining user profile, two-way speech communication, geopositioning and other factors to increase responder rate, or deliver information to a person nearby as to what treatment to take while waiting for first responders can, in the future, be combined with touch screen that can input physiological information.

The use of these functions on a cell phone will widely increase a user's desire to opt-into a cellular system and provide another level of service. In the future, it is anticipated that medical instrumentation that is specific to an individual, as well as specific physiological problems will be detectable by the cell phone itself and automatically transmit the need for help, possibly prior to the individual even knowing of the problem.

There is an existing business model in which phone centers are established in areas that have a display screen and a telephone. A person can use the telephone for free, but in exchange gets to see the advertising on the screen. This technology can modified to provide emergency information in the time of a natural disaster or a man-made disaster.

This system can be used to act as a communication device having both cellular as well as internet capability. In this way, this device can have special importance as a communication backup system. The entire system can also be used as a “See and Say” campaign to combat suspicious activity. Studies have shown that a lot of people do not want to get involved and are concerned that their own information will be tracked. This problem can be avoided with the use of systems described herein.

One of the functions of this system is that it can be “turned on” to government emergency messaging in a time of need. Certain features may be adapted from the conventional system at major intersections that will include external speakers and larger screens. Instead of selling advertising to people making free calls, this system can morph into an Emergency Center.

One of the features of this system is that, while preprogrammed with sophisticated software, unlike other broadcasting systems, the information changes dramatically depending on the type of emergency and the location of the person with respect to the emergency. As an example, if a dirty bomb goes off in Times Square, the messages at Times Square locations may tell people to stay where they are to avoid spreading the contamination. While on the same broadcast system the messages uptown or downtown are directing people not to go anywhere near Times Square. These messages will have many graduations depending o the emergency and the distance of our viewers to the emergency, as well as other transportation and other issues. They can also call for people with special training to be deployed to certain locations. It is also anticipated that people with GPS cell phones may also be able to pick up this location related emergency information.

The system can be coordinated with the Department of Homeland Security. The government can possibly pay nothing for this vital communication system, which will be supported by the owners of the patent pending technology on an advertising based model. The government may provide high traffic locations and the system may be given over to the governmental agencies as the needs arise. They can be as simple as weather issues, discontinued train service or other instructional information, other than catastrophes. It will setup an infrastructure that is serviced and maintained, but available to the government to break in at any time.

This communication system will supplement and enhance signals of cellular systems, switch carriers and most importantly provide sophisticated information, on a per location basis, in the event of an emergency or disaster. In some embodiments, large boards are setup which may not have telephonic connection. These systems might be linked by satellite, internet or other connection.

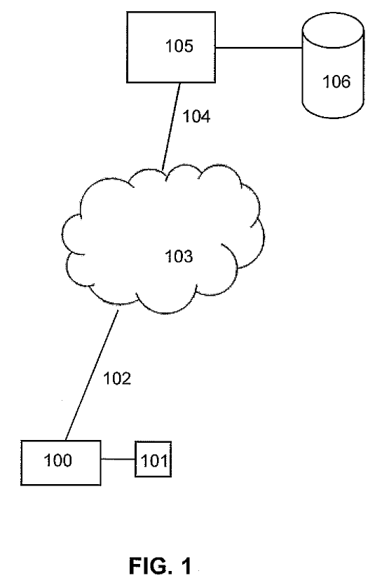

In one embodiment a GPS unit or receiver will be used as for instance shown in FIG. 1. Here, a personal computing device 100 such as a cell phone is connected to a GPS unit 101. Other personal computing devices can be used as well. By way of example only, personal digital assistants, laptop computers and personal computers or any other type of computing device can also be used. Further, there may be a plurality of such personal computing devices 100 and 101. Each of a plurality of first responders would be associated with the personal computing devices 100 and 101. The personal computing device 100 may provide the capability of the first responder associated with the device 100 entering an identification into the device 100 so the device 100 can be associated with a number of different persons, depending on who has the device 100 in their possession.

The positioning unit 101 may be integrated into a personal computing device 100. The personal computing device 100 can communicate through a connection 102. The personal computing device 100 has a transceiver to transmit and receive data to and from a network 103 through a connection channel 102. Such a connection may be a wireless connection. The connection 102 may also be a wired connection. The connection 102 connects to a network 103. The network 103 may be the Internet, it may also be a wireless network or part of a broadband network. The network 103 is any network that connects the device 100 to a central station 105 for alerting emergency responders. Station 105 is connected to network 103 through a connection 104, which may be a wired or a wireless connection. Station 105 may be in a fixed location, such as an emergency control center. Station 105 may also be mobile and set up at an emergency site. Station 105 has access to a databank 106.

In one embodiment the personal computing device 100 provides geographical information from GPS unit 101. In another embodiment the personal computing device 100 is a cell phone and the location of the device 100 is determined by a system that controls the cellular network. Location information in that case may not be as accurate as provided by GPS 101, but accurate enough to determine if the device 100 is in a region close to an emergency.

It is possible that responders have for instance cell phones that are in networks of different cellular network providers. Operational software exists that cuts across cellular services for contacting or polling users within different networks, and that may be used to gather information from potential emergency responders.

According to one or more aspects of the invention, systems are provided that is connected to a GPS system to which volunteers can opt-in or out. During an opt-in period emergency responders should not switch off or disable their personal computing device or GPS unit.

The system is connected to a databank 106 which comprises the names of potential emergency responders. Information about specific skills and training and other relevant information may be included. Part of the system may be a scheduling system that assigns potential responders a status of availability. Based on scheduled availability a potential emergency responder may want to opt-in to being tracked by the system by geographical location. To protect privacy, opting-in may be established by a willful act, for instance, by pushing a button on a device or by entering a code. As long as the emergency responder is opted-in, the geographical location of a device, potentially carried by the responder, is provided by the device to the system and provided to the databank 106. This can be done by polling of the device by the system or by programming a device to provide geographical information on a regular basis. After availability duty has been completed the system may stop tracking the emergency responder or the device may switch off tracking functions.

During opt-in the geographical location of an emergency responder with confirmed availability is known. The databank has access to training and skills and other relevant information of a registered responder. Part of relevant information may be opt-in for location tracking and confirmed availability for emergency duty. Accordingly when an emergency takes place, staff at an emergency control center may conduct a search in the databank that brings up the names and profiles of people with certain skills or backgrounds that are available and who are within a certain time of travel of the location of the emergency. Available responders with appropriate qualifications within travel distance may then be contacted and requested to report for duty. Such a call may be a phone call, an e-mail, a text message, a message on a web site or any message that will direct a responder to the location of an emergency.

In some situations direct communication with a potential first responder may not be possible. Based on reasonably recent information on the geographical location of a first responder one may decide to provide an alert for duty to a first responder and place it on a dedicated alert website. Such a website may be accessible by all qualified first responders. A website may also be accessible by only the first responder. This allows first responders, when an emergency is taking place, and for instance phone communications are interrupted or an emergency center can not be reached by phone, to check if reporting is required.

Increasingly, wireless and wired communications take place over the Internet or using an Internet protocol. Many locations in a city have for instance Wi-Fi stations. Each cell phone or personal computing device can transmit a unique identifying code either voluntarily or in response to a request from a base station or a Wi-Fi station. Such a unique identifying code can be transmitted to the emergency control center combined with known location of the base station or Wi-MAX station or of any other fixed station of which the location is known. Such a station can also transmit an alert, such as a ring tone, a voice mail or a text message to the personal computing device of a first responder. Such a message may also be automatically available on a website that is accessible to the first responder.

It may be required to redesign the entire grid for responders to reduce the time of response, avoid prompts, and not take up time with inappropriate responders. In the future, with broader training programs and more responders (potentially a significant percentage of the population), a computerized system, as disclosed as an aspect of the present invention, that registers the location of specifically trained responders may become increasingly important for the government and other agencies that have to respond to emergencies.

Further aspects of the invention are directed to emergency alert systems. A control center may be used to control messages flowing to a plurality of displays. The displays and the control center share a network, which can be wireless, wired, satellite, or any other suitable network. The displays are mainly located outside of the control center, with some being in the control center, as needed. The global position of each of the displays is known to the control center software. The global position can be hard-wired into the display, programmed into the software, transmitted dynamically by use of a GPS system, or by any other suitable locating means. Software run from the control center controls the messages that appear on the displays.

The message shown on the display can be interrupted or changed by a local, state, federal government or government agency as needed. This governmental change can be accomplished by either control from outside of the control center or by communication with the control center.

The displays of some aspects of the invention display a message based on the global position of the display. For example, displays within a disaster area may provide instructions to the people or emergency crews within the area. Whereas, the displays outside of the disaster area may direct people away from the scene.

Other embodiments of the system include a standard telephone. This telephone may be a pay phone or free for anyone's use. The displays of these and other embodiments may include an advertisement or series of advertisements which the telephone user is presented with during their phone call. If an emergency message is used, the advertisement will be interrupted for the message.

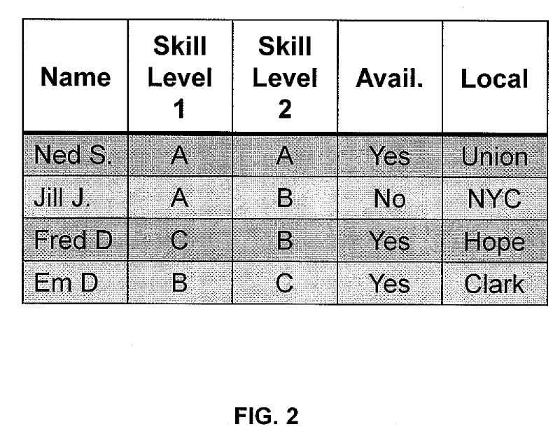

FIG. 2 illustrates one embodiment of a databank in accordance with an aspect of the present invention. The databank includes a plurality of first responders. In this case, Ned S., Jill, J, Fred D. and Em D are the first responders. Each of the first responders has one or more associated skill levels. The skill levels can indicated different skills. For example, skill level 1 may indicate the ability to deal with hazardous materials. Skill level 2 may indicate the ability to deal with injured persons. Other skill levels can be included in the databank of FIG. 2. The databank also includes an availability of the first responder. This can be provided by the first responder entering the availability into his or her associated personal computing device. Alternatively, the availability can be assigned by the emergency control center or by any other means possible. The location of the first responder is also provided in the databank. The location is preferably provided by the information provided by the positioning unit 101 for each first responder.

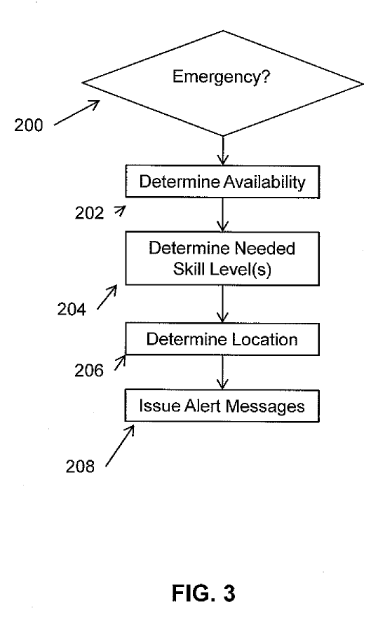

FIG. 3 illustrates the steps performed by the emergency control center 105 in accordance with one aspect of the present invention. In step 200, the emergency control center 105 receives an emergency notification. The notification specifies the type of emergency and the location of the emergency. In step 202, the emergency control center, which includes a processing center that accesses the databank 106, searches the databank 106 for available first responders. Using the example of FIG. 2, Ned S., Fred D. and Em D. would be available.

Then in step 204, the emergency control center 105, determines the skill level or levels needed by a first responder to adequately respond to the emergency. The emergency control center 105 does this based on the type of emergency received in step 200. This information can be preprogrammed into the emergency control center 105. So, for example, a hazmat emergency may need at least one person with an A hazmat rating.

In step 206, the emergency control center 105 determines the location of each of the first responders and their distance from the emergency location. This determination is made based on the location information concerning the emergency from step 200 and from the location information of each first responder provided by the personal computing device 100 and positioning unit 101 associated with each first responder.

Then in step 208, the emergency control center determines which first responders to dispatch to the emergency. The decision as to which first responders to dispatch is made based on their skill levels and their location in relation to the type of emergency and the location of the emergency. The decision is also made based on the availability of the first responders.

Based on this determination, the emergency control center issues a message to one or more first responders to respond the emergency. The message is displayed on the personal computing device associated with the selected first responders (which is also stored in the databank). The message can be an email communication, a light, a text message, an alarm or any other type of message. The message can specify the location of the emergency and the type of emergency.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A system for alerting one or more of a plurality of first responders to report for duty in case of an emergency event, comprising:
an emergency control center, including a databank comprising information on each of the plurality of first responders, the information including one or more skills or levels of each of the plurality of first responders;
a network;
a plurality of personal computing devices enabled to communicate with the emergency control center, each of the plurality of personal computing devices and/or other devices capable of:
having a system to provide information concerning a location of the responder;
being associated with one of the plurality of first responders and communication receiving ability from the one of the plurality of first responders; and
being able to communicate the information concerning the location and/or availability of the one of the plurality of first responders to the emergency control center; and
application software enabling the emergency control center to select from the databank one or more of the plurality of first responders for duty based on the information available at the emergency control center

2. The system as claimed in claim 1, further comprising a message transmitted from the emergency control center to one or more of the plurality of personal computing devices to alert the responder to report for duty.

3. The system as claimed in claim 1, wherein the personal computing device is selected from the group consisting of: a cell phone, a personal digital assistant, a portable computer, a personal computer.

4. The system as claimed in claim 1, wherein the positioning unit is a Global Positioning System (GPS) receiver or other location based system.

5. The system as claimed in claim 1, wherein the network comprises a wireless network.

6. The system as claimed in claim 1, wherein each of the personal computing devices can receive an identification of the first responder carrying the personal computing device and transmit the identification to the emergency control center.

7. A method for alerting a first responder to report for duty in case of an emergency event by using a skill level of the first responder stored in a databank, comprising the steps of:
tracking a geographical location of the first responder through a network;
determining an availability of the first responder;
selecting the first responder based on the geographical location, the availability and the skill level; and
alerting the first responder to report for duty.

8. The method as claimed in claim 7, wherein the first responder has opted-in for the tracking of the geographical location.

9. The method as claimed in claim 7, wherein the network comprises a wireless network.

10. The method as claimed in claim 7, wherein the geographical location is determined by a global positioning system (GPS) receiver.

11. An emergency alert system comprising:
a control center;
a network;
a plurality of displays in communication with the network for presenting a message, the displays being located outside of the control center and having a known global position; and
software enabling the control center to control the messages appearing on the displays,
wherein the messages can be controlled by a local, state or federal government in the case of an emergency based on the geographical position of the display.

12. The system of claim 11, wherein the position of the individual display is determined by a Global Positioning System (GPS).

13. The system of claim 11, wherein the message appearing on the display is dependent upon the global position of the display.

14. The system of claim 13, wherein the message appearing on the display depends on a skill level associated with a person carrying the display.

15. The system of claim 11, wherein the message on the display is an advertisement which can be interrupted for an emergency message.

16. The system of claim 11, further comprising a telephone.

17. The system of claim 16, wherein the telephone can be used for free while the advertisement is played on the display.
